(19) United States
(12) Patent Application Publication
(10) Pub. No.: US 2026/0204765 A1
(43) Pub. Date: Jul. 16, 2026

(54) ANTENNA MOUNT AND RELATED SYSTEMS AND ASSEMBLIES

(71) Applicant: Outdoor Wireless Networks LLC, Richardson, TX (US)

(72) Inventors: Bin Ai, Suzhou (CN); Chao Bu, Suzhou (CN); Charles J. Mann, Omaha, NE (US)

(21) Appl. No.: 19/438,831

(22) Filed: Jan. 2, 2026

(30) Foreign Application Priority Data
Jan. 14, 2025 (CN) 202510052930.X

(51) Int. Cl. H01Q 1/12; H01Q 3/02

(52) U.S. Cl. CPC H01Q 1/1228; H01Q 3/02

(57) ABSTRACT

The present disclosure is directed to an antenna mount. The antenna mount includes a vertical mounting pipe configured to have an antenna mounted thereto, a bracket assembly configured to secure the vertical mounting pipe to a mounting structure, and one or more tie-back pipe members configured to further secure the vertical mounting pipe to the mounting structure. The bracket assembly includes a base pipe member, an upper bracket member coupled to an end of the base pipe member, and a lower bracket assembly coupled to an opposing end of the base pipe member. An azimuth adjustment system utilizing two or more of the antenna mounts is also described herein.

### RELATED APPLICATION(S)

This application claims priority to and the benefit of Chinese Patent Application for Invention No. 202510052930.X, filed on Jan. 14, 2025, the disclosures of which are incorporated herein by reference in full.

### FIELD

The present invention generally relates to telecommunications equipment and, more particularly, an antenna mount adaptable for use in different rooftop mounting positions.

### BACKGROUND

Nodes and satellite antennas are typically lightweight devices deployed outdoors. Currently, as shown in FIGS. 1A-1D, these antennas 10₁₋₄ are usually installed on various types of roofs, such gable roofs 20A (as shown in FIG. 1A), flat roofs 20B (as shown in FIG. 1B), vertical walls 20C (as shown in FIG. 1C) or under the roof eaves 20D (as shown in FIG. 1D). Each of these different installation scenarios often require different antenna mounts, which can be inconvenient. An example of a currently available antenna mount is illustrated in FIG. 2. As shown in FIG. 2, the antenna mount 30 includes a bent pipe 32 to achieve a fixed bending angle (α), which means that the span (S) of the bent pipe 32 is also fixed (see FIG. 2 insert). As further shown in FIG. 2, the antenna mount 30 also includes a lower bracket 34 and tie-back pipes 36 that are used to secure the antenna mount 30 to the different roof structures such as the roofs 20A, 20B, 20C, 20D shown in FIGS. 1A-1D. However, the antenna mount 30 has some potential drawbacks. For example, the bent pipe 32 is non-standard and requires additional processing to manufacture. The bending angle (α) and span (S) of the bent pipe 32 are fixed and cannot be adjusted. Also, the integrated design of the lower bracket 34 and the tie-back pipes 36 with flattened ends 35, 37 requires stamping molds, and thus, production is unsuitable for small batches. Therefore, developing an antenna mount that can adapt to different installation scenarios may be desired.

### SUMMARY

Embodiments of the present invention are directed to an antenna mount. The antenna mount includes a vertical mounting pipe configured to have an antenna mounted thereto, a bracket assembly configured to secure the vertical mounting pipe to a mounting structure, and one or more tie-back pipe members configured to further secure the vertical mounting pipe to the mounting structure. The bracket assembly includes a base pipe member, an upper bracket member coupled to an end of the base pipe member, and a lower bracket assembly coupled to an opposing end of the base pipe member.

Further embodiments of the present invention are directed to an antenna mount. The antenna mount includes a vertical mounting pipe configured to have an antenna mounted thereto, a bracket assembly configured to secure the vertical mounting pipe to a mounting structure, one or more tie-back pipe members, and one or more pipe clamps. The bracket assembly includes a base pipe member, an upper bracket member coupled to an end of the base pipe member and configured to be secured to the vertical mounting pipe, and a lower bracket assembly configured to be secured to the mounting structure. The lower bracket assembly includes two bracket members configured to clamp an opposing end of the base pipe member therebetween. Each tie-back pipe member includes a mounting bracket coupled to an end that is configured to be secured to the mounting structure and each pipe clamp is configured to engage the vertical mounting pipe and a respective tie-back pipe member.

Further embodiments of the present invention are directed to an azimuth adjustment system. The azimuth adjustment system includes two or more antenna mounts. Each antenna mount is mounted to a vertical wall, and the vertical mounting pipes for each antenna mount are positioned at different distances from the vertical wall, thereby allowing an antenna mounted to each vertical mounting pipe to be positioned to face a target azimuth direction without interference from an adjacent antenna.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIGS. 1A-1D illustrate prior known antenna mounts.

FIG. 2 illustrates another prior known antenna mount.

FIG. 3A is a front perspective view of an antenna mount according to embodiments of the present invention.

FIG. 3B is a rear perspective view of the antenna mount shown in FIG. 3A.

FIG. 3C is a side view of the antenna mount shown in FIG. 3A.

FIG. 4A is a top perspective view of a bracket assembly for the antenna mount shown in FIGS. 3A-3C according to embodiments of the present invention.

FIG. 4B is another top perspective view of the bracket assembly shown in FIG. 4A.

FIG. 4C is a side view of the bracket assembly shown in FIG. 4A.

FIG. 5A is top perspective view of an upper bracket member for the bracket assembly shown in FIGS. 4A-4C according to embodiments of the present invention.

FIG. 5B is another top perspective view of the upper bracket member shown in FIG. 5A

FIG. 6 is a perspective view of one of the bracket members for the lower bracket assembly of the bracket assembly shown in FIGS. 4A-4C according to embodiments of the present invention.

FIG. 7A is an enlarged top perspective view of the boxed section labeled in FIG. 3B illustrating engagement of the tie-back pipe members and the antenna mounting pipe for the antenna mount via pipe clamps according to embodiments of the present invention.

FIG. 7B is a top perspective view of one of the pipe clamps shown in FIG. 7A according to embodiments of the present invention.

FIG. 7C is a top perspective view of a mounting bracket for the tie-back pipe members according to embodiments of the present invention.

FIGS. 8A-8E illustrate example mounting options for the antenna mount shown in FIGS. 3A-3C according to embodiments of the present invention.

FIGS. 9A-9C illustrate the adaptability of the antenna mount shown in FIGS. 3A-3C according to embodiments of the present invention.

FIGS. 10A-10E illustrate example steps for installing the antenna mount shown in FIGS. 3A-3C on a mounting structure according to embodiments of the present invention.

FIG. 11A is a front view of an azimuth adjustment system utilizing the antenna mount shown in FIGS. 3A-3C according to embodiments of the present invention.

FIG. 11B is a top perspective view of the azimuth adjustment system shown in FIG. 11A.

FIG. 11C is a top view of the azimuth adjustment system shown in FIG. 11A.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

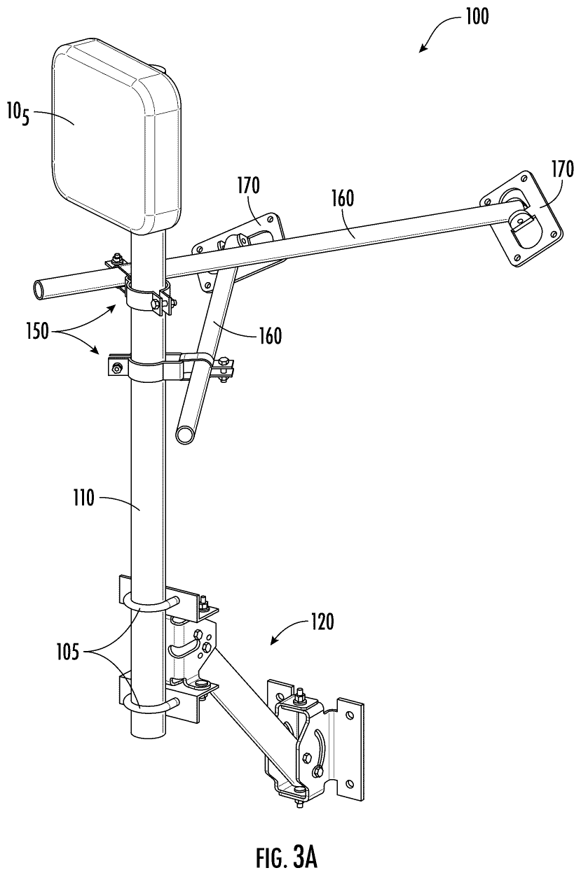

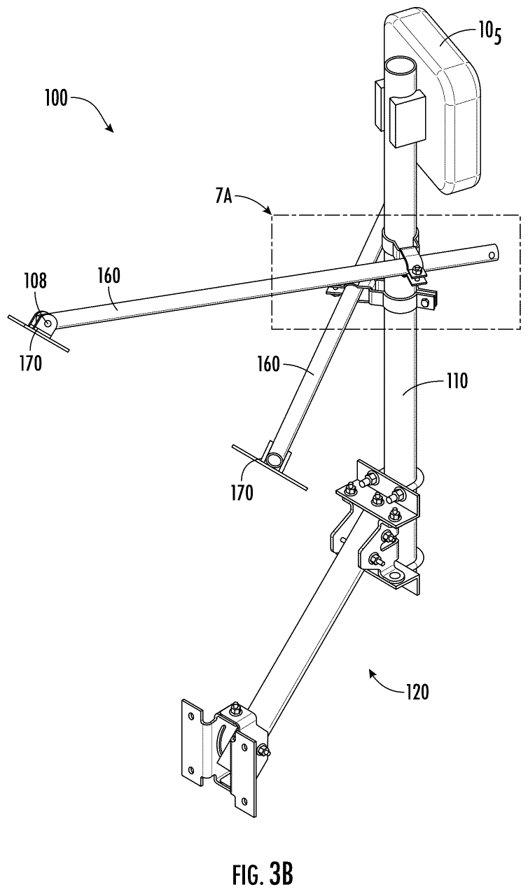

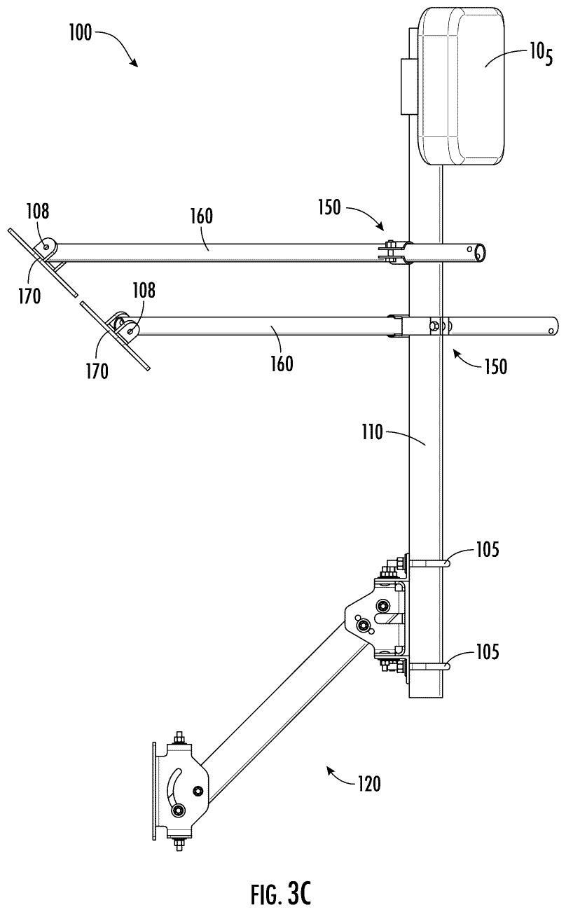

Pursuant to embodiments of the present invention, an antenna mount is provided. According to embodiments of the present invention, the antenna mount provides flexible angle adjustment capabilities, allowing the mount to adapt to different rooftop installation scenarios and various roof pitches. In other embodiments of the present invention, two or more of the antenna mounts may form part of an azimuth adjustment system configured to create skew adjustments to face respective mounted antennas in a target azimuth direction. Embodiments of the present invention will now be discussed in greater detail with reference to FIGS. 3A-11C.

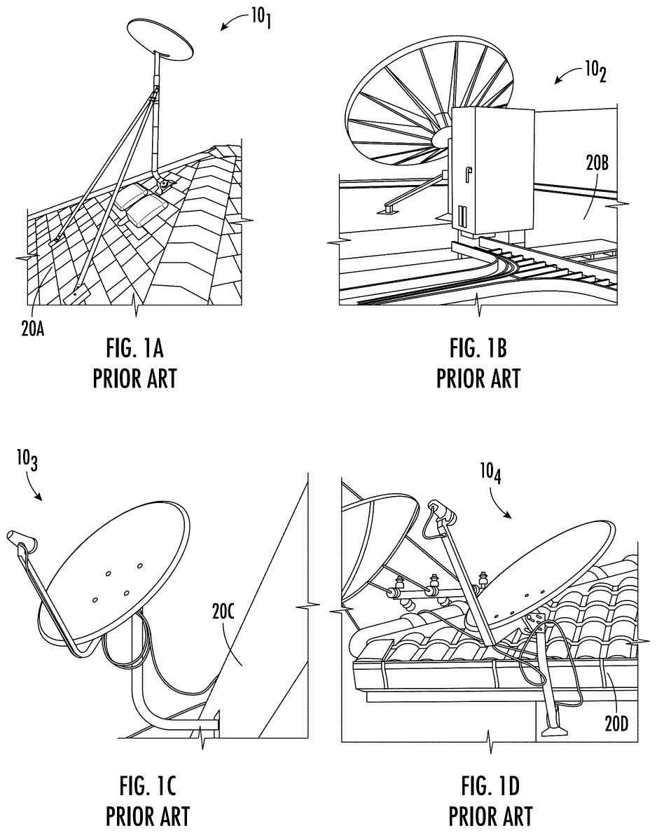

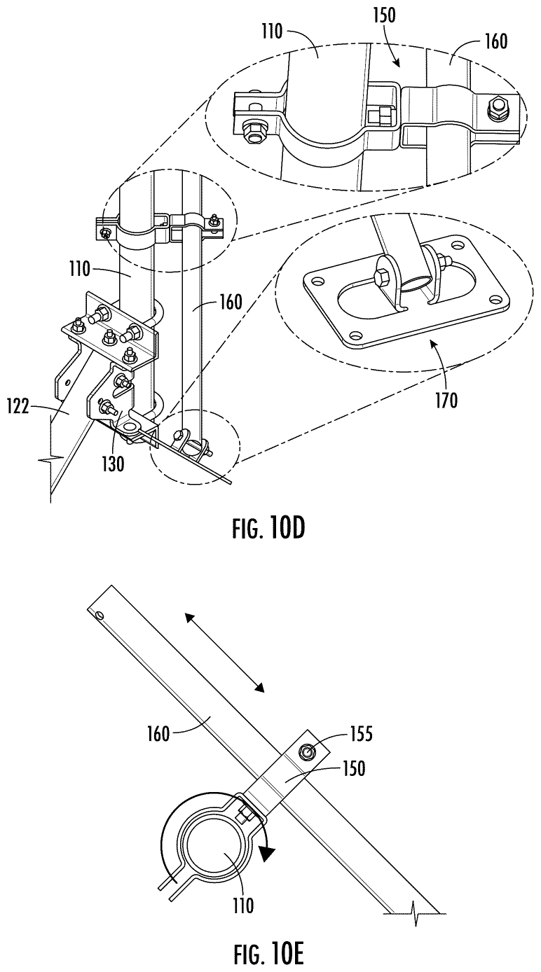

Referring now to FIGS. 3A-3C, an antenna mount according to embodiments of the present invention, designated broadly 100, is illustrated. The antenna mount 100 is adaptable for use in different rooftop mounting positions (i.e., a rooftop antenna mount). As shown in FIG. 3A-3C, in some embodiments, the antenna mount 100 comprises an antenna mounting pipe 110. The antenna mounting pipe 110 is configured to have an antenna 10₅ mounted thereto. It is noted that while the antenna 10₅ illustrated in FIGS. 3A-3C is shown as a remote node, the type of antenna that may be mounted to the antenna mounting pipe 110 is not limited thereto, and may include other types of antennas 10₁₋₄ such as those illustrated in FIGS. 1A-1D, as well as the base station antenna 10₆ illustrated in FIGS. 10A-10C.

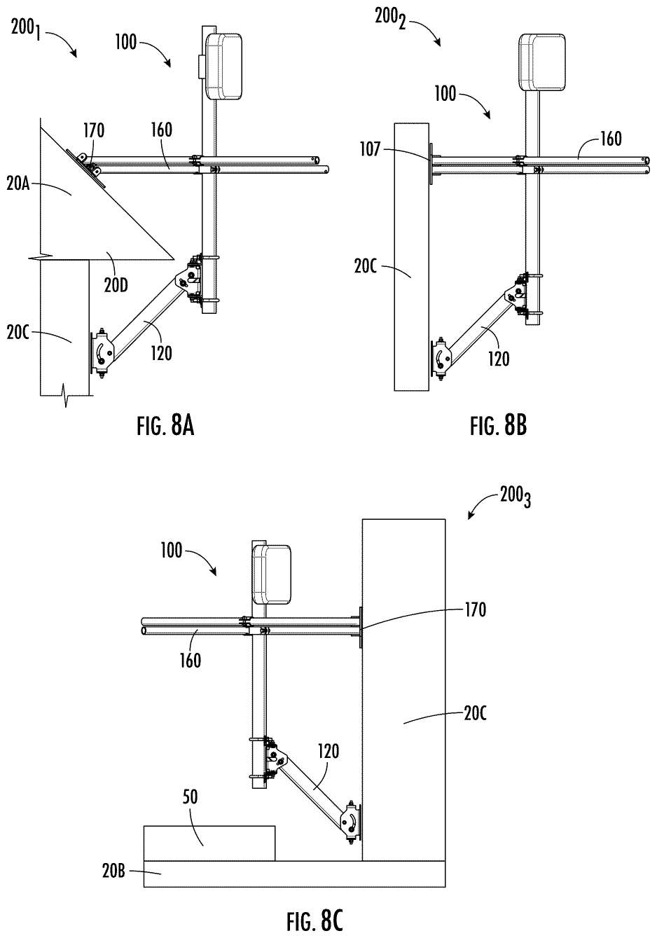

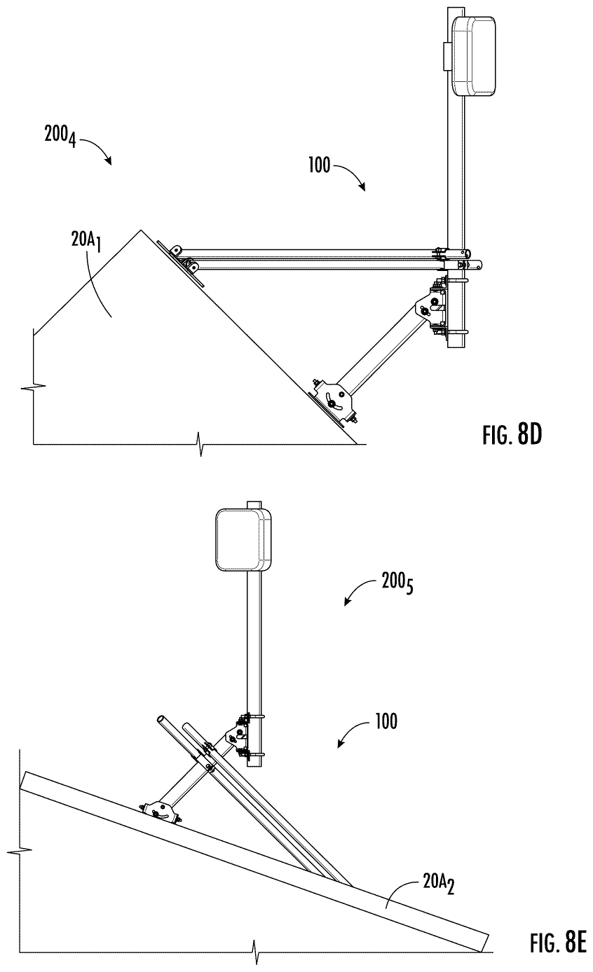

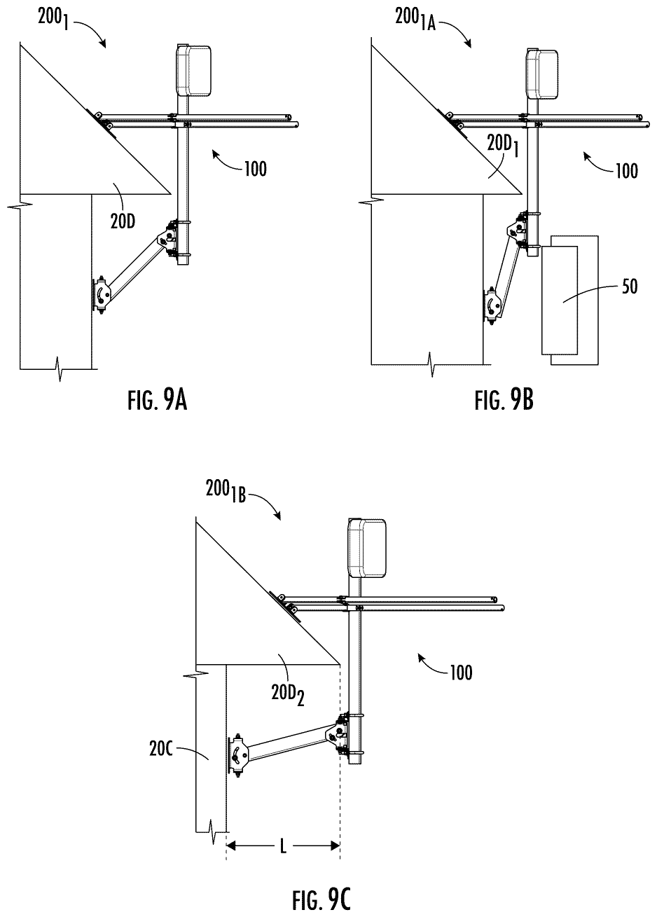

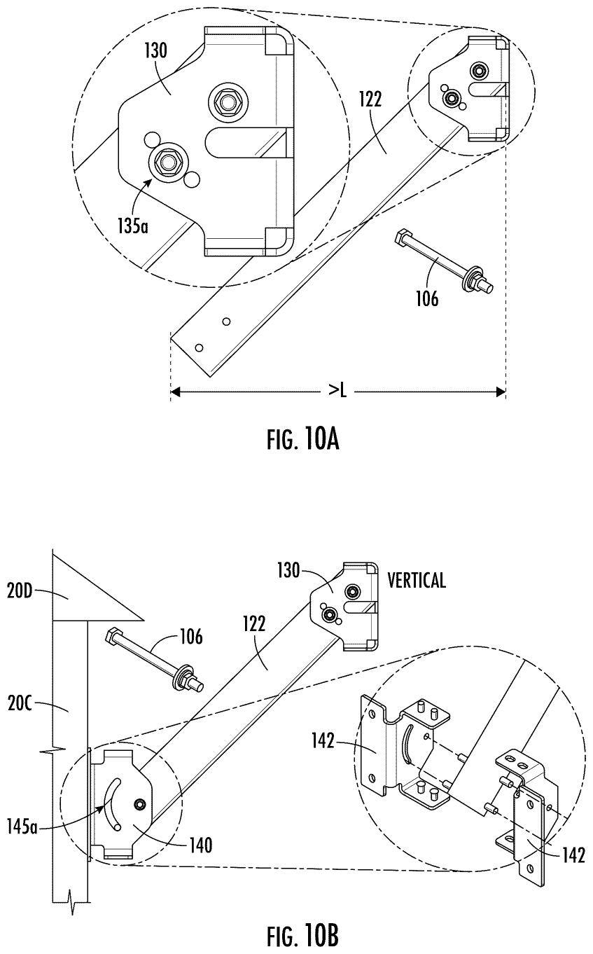

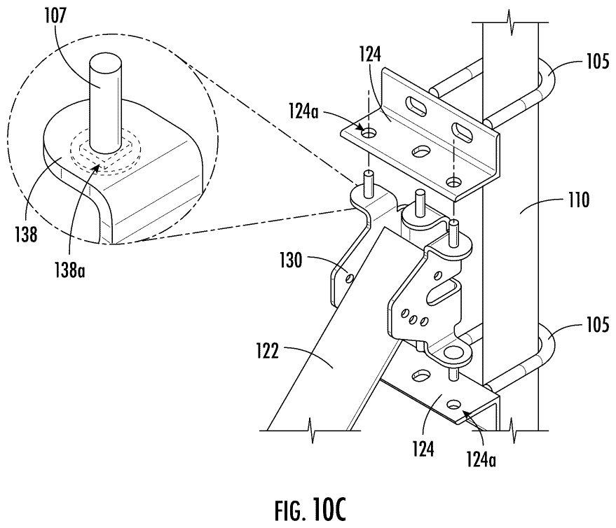

As further shown in FIGS. 3A-3C, in some embodiments, the antenna mount 100 of the present invention may further comprise a bracket assembly 120. In some embodiments, the bracket assembly 120 is configured to be secured to the antenna mounting pipe 110, for example, via fasteners 105 (e.g., U-bolt fasteners). As described in further detail below, the bracket assembly 120 is configured to secure the antenna mount 100 to a mounting structure 20 (e.g., rooftop or associated structure) (see, e.g., FIGS. 8A-8E and FIGS. 9A-9C). In some embodiments, the antenna mount 100 may also comprise one or more tie-back pipe members 160. The tie-back pipe members 160 may be secured to the antenna mounting pipe 110 via pipe clamps 150 (see also, e.g., FIG. 7A). In some embodiments, a mounting bracket 170 may reside at an end of each respective tie-back pipe member 160. The mounting brackets 170 (and tie-back pipe members 160) are configured to further secure the antenna mount 100 to the mounting structure 20 (see, e.g., FIGS. 8A-8E and FIGS. 9A-9C). Each of these components will be described in further detail below.

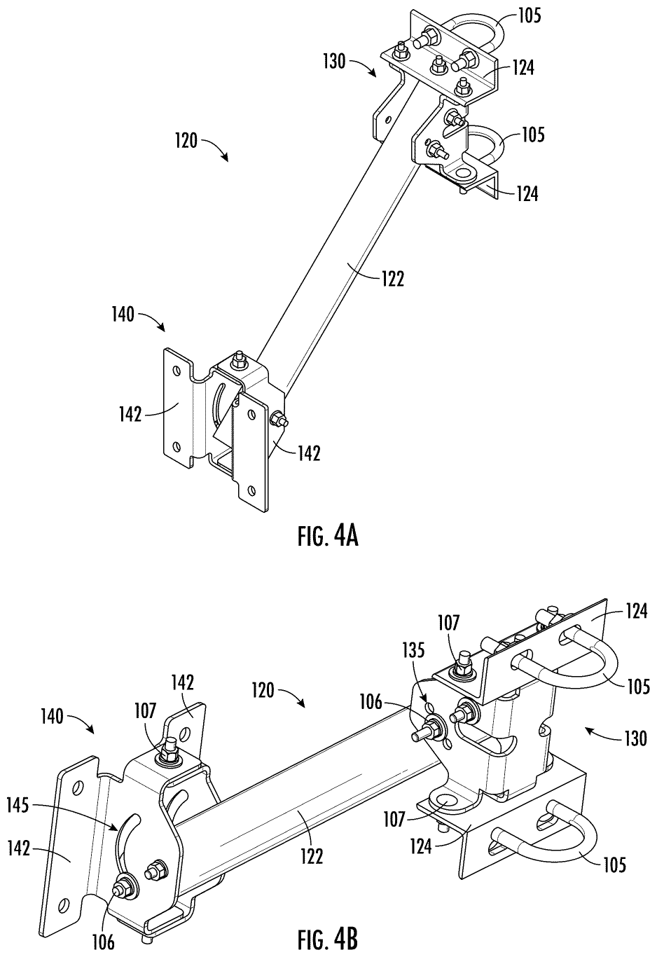

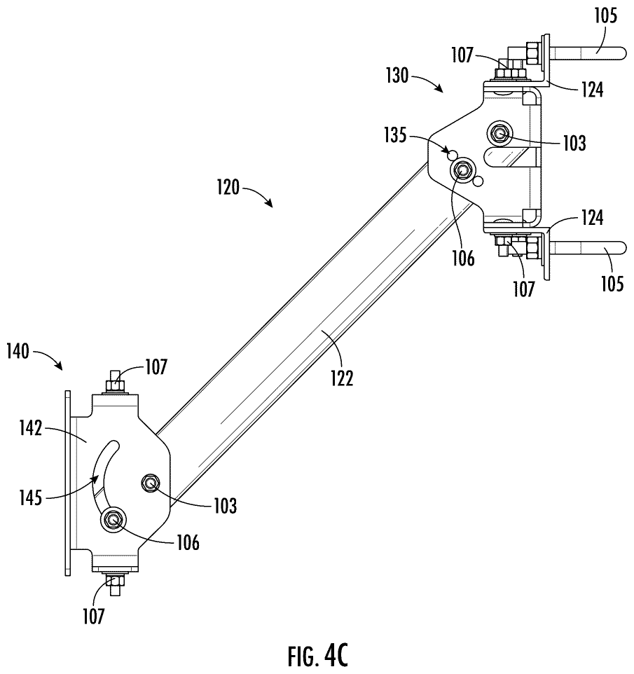

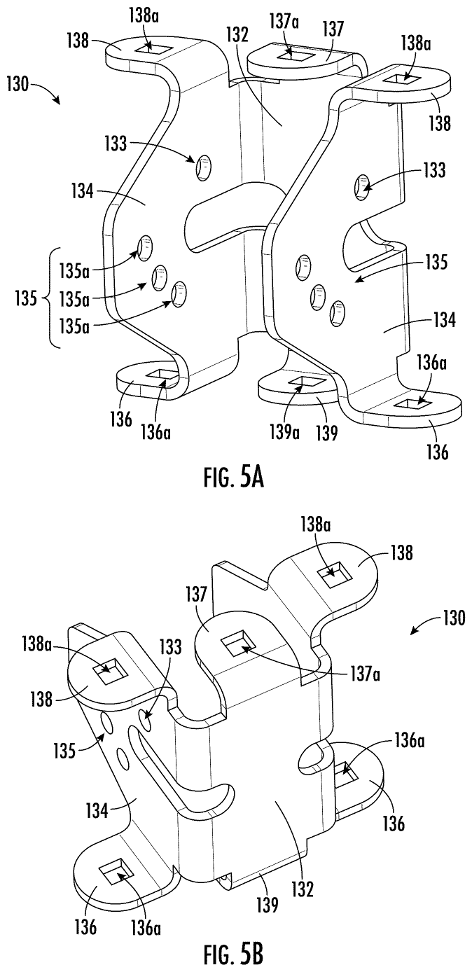

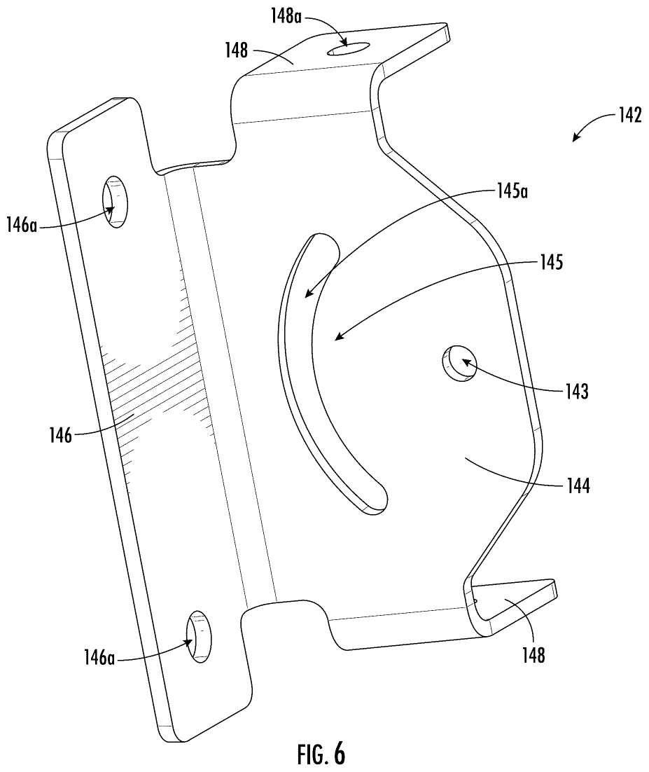

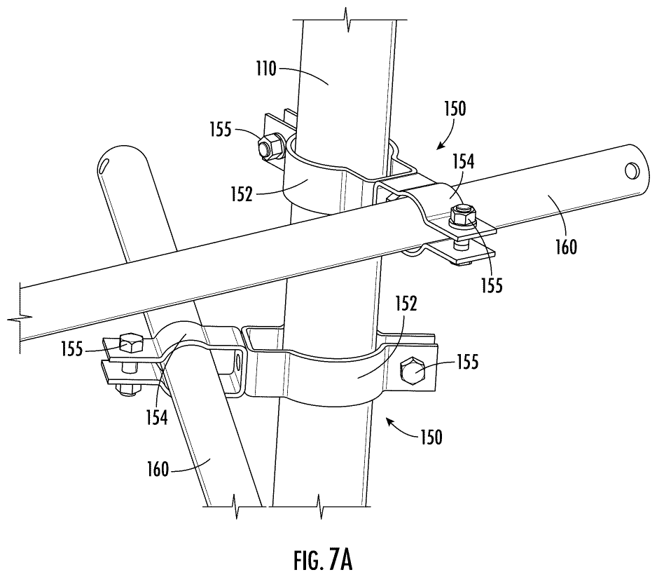

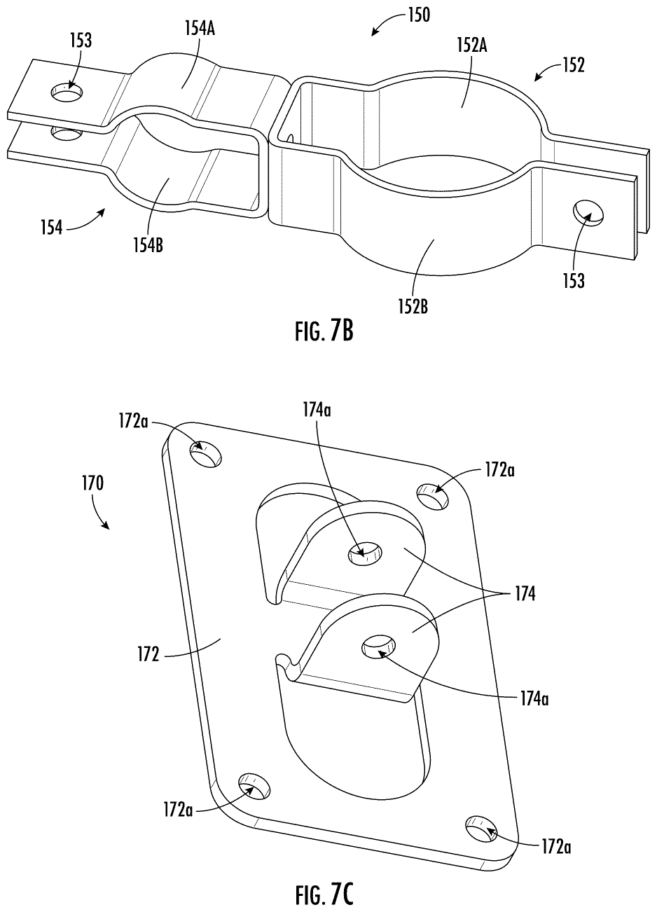

Referring to FIGS. 4A-4C, the bracket assembly 120 for the antenna mount 100 is illustrated in greater detail. As shown in FIGS. 4A-4C, the bracket assembly 120 comprises a base pipe member 122. An upper bracket 130 is coupled to an end of the base pipe member 122. The upper bracket member 130 is configured to be secured to the antenna mounting pipe 110 of the bracket assembly 120 (see also FIGS. 5A-5B). The bracket assembly 120 further comprises a lower bracket assembly 140 coupled to an opposing end of the base pipe member 122. The lower bracket assembly 140 is configured to be secured to the mounting structure 20. In some embodiments, the lower bracket assembly 140 may comprise two bracket members 142 that are configured to clamp the end of the base pipe member 122 therebetween (see also FIG. 6). As described in further detail below, in some embodiments, the upper bracket member 130 and the lower bracket assembly 140 may comprise respective adjustment mechanisms 135, 145 which allow the angle at which the base pipe member 122 is coupled thereto to be adjusted to accommodate different mounting scenarios, for example, as shown in FIGS. 8A-8E and FIGS. 9A-9C.

Referring to FIGS. 5A-5B, the upper bracket member 130 for the bracket assembly 120 is illustrated in greater detail. As shown in FIGS. 5A-5B, in some embodiments, the upper bracket member 130 comprises a main section 132 having opposing side members 134 extending outwardly therefrom. The side members 134 extend perpendicularly to the main section 132 and parallel to each other and are configured to engage (be secured to) opposing sides of the base pipe member 122 (i.e., the base pipe member 122 is secured between the side members 134 of the upper bracket member 130) (see e.g., FIGS. 4A-4C).

As discussed above, in some embodiments, the upper bracket member 130 comprises an adjustment mechanism 135. As shown in FIGS. 5A-5B, in some embodiments, the adjustment mechanism 135 resides in the side members 134 of the upper bracket member 130. For example, in some embodiments, the adjustment mechanism 135 may comprise a plurality apertures 135a in each side member 134 of the upper bracket member 130. The apertures 135a of the adjustment mechanism 135 are configured to receive a fastener 106 therethrough to secure the upper bracket member 130 to the base pipe member 122. In some embodiments, the adjustment mechanism 135 may comprise three apertures 135a which allows for three levels of angular adjustment between the upper bracket member 130 and the base pipe member 122.

As further shown in FIGS. 5A-5B, in some embodiments, the upper bracket member 130 comprises a plurality of flanged ends 136, 137, 138, 139. For example, in some embodiments, each side member 134 comprises an upper flanged end 138 and a lower flanged end 136, and the main section 132 comprises an upper flanged end 137 and a lower flanged end 139. One or more of the upper and lower flanged ends 136, 137, 138, 139 are configured to engage a respective mounting plate 124 which allows the upper bracket member 130 to secure the bracket assembly 120 to the antenna mounting pipe 110 (see also, e.g., FIGS. 4A-4C).

For example, referring back to FIGS. 4A-4C, in some embodiments, a first mounting plate 124 is configured to engage the lower flanged ends 136, 139 of the side members 134 and the main section 132, respectively, and a second mounting plate 124 is configured to engage the upper flanged ends 137, 138 of the side members 134 and the main section 132, respectively. The mounting plates 124 may be secured to the upper bracket member 130 via fasteners 107 received through apertures 136a, 137a, 138a, 139a in the respective upper and lower flanged ends 136, 137, 138, 139. In some embodiments, the mounting plates 132 are bent (e.g., L-shaped) and configured to receive fasteners 105 (e.g., U-bolt fasteners) to secure the bracket assembly 120 to the antenna mounting pipe 110.

Still referring to FIGS. 5A-5B, in some embodiments, each side member 134 may also comprise an additional aperture 133 that is separate and apart from the plurality of apertures 135a of the adjustment mechanism 135. The additional aperture 133 in each side member 134 is configured to receive a separate fastener 103. The separate fasteners 103 further secure the upper bracket member 130 to the base pipe member 122. In addition, the separate fasteners 103 provide pivot points which allow an angular adjustment to be made between the base pipe member 122 and the upper bracket member 130 while maintaining engagement between the baser pipe member 122 and the upper bracket member 130. In other words, to make an angular adjustment between the base pipe member 122 and the upper bracket member 130, the fasteners 106 may be removed from the respective apertures 135a of the adjustment mechanism 135 while the base pipe member 122 remains secured to the upper bracket member 130 via the separate fasteners 103. The base pipe member 122 may then be moved relative to the upper bracket member 130 (i.e., pivot about fasteners 103) to align with the desired apertures 135a of the adjustment mechanism 135. The fasteners 106 may then be inserted into the corresponding apertures 135a of the adjustment mechanism 135 to set the new angular position between the base pipe member 122 and the upper bracket member 130.

Referring now to FIG. 6, one of the bracket members 142 of the lower bracket assembly 140 is illustrated in greater detail. As noted above, in some embodiments, the lower bracket assembly 140 may comprise two bracket members 142 (the bracket members 142 being identical) that are configured to clamp the end of the base pipe member 122 therebetween. In some embodiments, the bracket member 142 is bent (e.g., L-shaped). As shown in FIG. 6, the bracket member 142 has a first section 146 configured to be secured to the mounting structure 20. For example, the first section 146 may comprise one or more apertures 146a configured to receive a fastener (not shown) to secure the bracket member 142 to the mounting structure 20. The bracket member 142 also has a second section 144 extending perpendicularly to the first section 146. The second section 144 has opposing flanged edges 148. Each flanged edge 148 comprises and aperture 148a. The apertures 148a in corresponding flanged edges 148 of each bracket member 142 are configured to align with each other and receive a respective fastener 107 to secure the bracket members 142 together, thereby forming the lower bracket assembly 140 and secure an end of the base pipe member 122 therebetween (see, e.g., FIGS. 4A-4C).

As discussed above, the lower bracket assembly 140 comprises an adjustment mechanism 145. As shown in FIG. 6, in some embodiments, the adjustment mechanism 145 may comprise an arcuate slot 145a in the second section 144 of each bracket member 142. The slot 145 is configured to receive a fastener 106. The fastener 106 is able to traverse within the slot 145a of the adjustment mechanism 145, thereby allowing continuous angular adjustments to be made between the lower bracket assembly 140 and the base pipe member 122.

As further shown in FIG. 6, similar to the upper bracket member 130, in some embodiments, the second section 144 may also comprise an aperture 143 that is separate and apart from the slot 145a of the adjustment mechanism 145. The aperture 143 is configured to receive a separate fastener 103. The separate fasteners 103 further secure each bracket member 142 of the lower bracket assembly 140 to the base pipe member 122. In addition, similar to the fasteners 103 that secure the upper bracket member 130 to the base pipe member 122, the separate fasteners 103 provide pivot points which allow an angular adjustment to be made between the base pipe member 122 and the lower bracket assembly 140 while maintaining engagement between the base pipe member 122 and the lower bracket assembly 140. In other words, to make an angular adjustment between the base pipe member 122 and the lower bracket assembly 140, the fasteners 106 inserted through the slot 145a of the adjustment mechanism 145 may be loosened and slide within the slot 145a while the base pipe member 122 remains secured to the lower bracket assembly 140 via the separate fasteners 103. The base pipe member 122 may then be moved relative to the lower bracket assembly 140 (i.e., pivot about fasteners 103) to slide the fasteners 106 within the corresponding slots 145a until the desired angular position is achieved. The fasteners 106 may then be tightened to secure the adjustment mechanism 145 and set the new angular position between the base pipe member 122 and the lower bracket assembly 140.

FIGS. 7A-7C illustrate the tie-back pipe members 160 and associated components (i.e., pipe clamp and mounting bracket) in greater detail. FIG. 7A is an enlarged top perspective view of the boxed section labeled in FIG. 3B illustrating engagement of the tie-back pipe members and the antenna mounting pipe. As shown in FIG. 7A, each tie-back pipe member 160 may be secured to the antenna mounting pipe 110 via a respective pipe clamp 150. The tie-back pipe members 160 are configured to provide additional support to the antenna mount 100 and help to further secure the antenna mount 100 to the mounting structure 20 (see, e.g., FIGS. 8A-8E and FIGS. 9A-9C). As described in further detail below, the tie-back pipe members 160 are also configured to be moved and rotated to achieve the proper/desired installation position on the mounting structure 20.

FIG. 7B shows one of the pipe clamps 150 in greater detail. In some embodiments, the pipe clamp 150 is configured (adaptable) to engage different diameter antenna mounting pipes 110. As shown in FIG. 7B, in some embodiments, the pipe clamp 150 comprises a first clamping section 152 having a corresponding pair of clamp arms 152A, 152B coupled to a second clamping section 154 having a corresponding pair of clamp arms 154A, 154B. In some embodiments, the first clamping section 152 is configured to engage the antenna mounting pipe 110 and the second clamping section 154 is configured to engage a respective tie-back pipe member 160. In some embodiments, the first clamping section 152 is positioned orthogonal to the second clamping section 154. For example, in some embodiments, first clamping section 152 is positioned to engage a generally vertically extending antenna mounting pipe 110 and the second clamping section 154 is positioned to engage a generally horizontally extending tie-back pipe member 160 (see also, e.g., FIG. 7A). Each clamp arm 152A, 152B, 154A, 154B comprises a corresponding aperture 153. As shown in FIG. 7A, the apertures 153 of corresponding clamp arms (i.e., 152A/152B and 154A/154B) are aligned to receive a fastener 155 to secure the corresponding tie-back pipe member 160 in a desired position relative to the antenna mounting pipe 110, and vice versa.

FIG. 7C illustrates one of the mounting brackets 170 for the tie-back pipe members 160 Each mounting bracket 170 is coupled to an end of a respective tie-back pipe member 160 (see, e.g., FIGS. 3A-3C). The mounting brackets 170 are configured to secure the respective tie-back pipe member 160 to the mounting structure 20 (see, e.g., FIGS. 8A-8E and FIGS. 9A-9C). In some embodiments, each mounting bracket 170 comprises a base plate 172 having a pair of tab members 174 extending upwardly therefrom. The corresponding end of the respective tie-back pipe member 160 is configured to fit and be secured between the tab members 174. In some embodiments, each tab member 174 comprises an aperture 174a. The apertures 174a are configured to receive a fastener 108 to secure the mounting bracket 170 to the tie-back pipe member 160 (see, e.g., FIGS. 3B-3C). In some embodiments, the mounting bracket 170 is configured to move relative to tie-back pipe member 160 (e.g., pivot about fastener 108), thereby allowing the mounting bracket 170 to be secured to an angled mounting structure 20 (see, e.g., FIG. 8A, FIG. 8D and FIG. 8E).

FIGS. 8A-8E illustrate example mounting assemblies 200₁, 200₂, 200₃, 200₄, 200₅ for the antenna mount 100 (e.g., rooftop installations) according to embodiments of the present invention. FIG. 8A illustrates a first mounting assembly 2001 in which the antenna mount 100 is secured under a roof eave 20D (similar to as shown in FIG. 1D). As shown in FIG. 8A, the bracket assembly 120 of the antenna mount 100 is secured to a vertical wall 20C under the roof eave 20D and the mounting brackets 170 secure the tie-back pipe members 160 to a gable roof 20A. FIG. 8B illustrates a second mounting assembly 200₂ in which the antenna mount 100 is secured to a vertical wall 20C (without a roof eave) (e.g., exterior surface of the vertical wall 20C) with the bracket assembly 120 and the mounting brackets 170 for the tie-back pipe members 160 being secured to the vertical wall 20C. FIG. 8C illustrates a third mounting assembly 200₃ in which the antenna mount 100 is secured to an interior surface of a vertical wall 20C (such as a parapet wall). As further shown in FIG. 8C, in some embodiments, the antenna mount 100 may be configured to be mountable to avoid obstacles 50, for example, that may reside on a corresponding flat roof 20B. FIGS. 8D-8E illustrate a fourth mounting assembly 2004 and a fifth mounting assembly 200₅ which show the ability of the antenna mount 100 to be mounted to gable roofs 20A₁, 20A₂ having different pitches/slopes. As shown in FIGS. 8D-8E, the bracket assembly 120 and the mounting brackets 170 for the tie-back pipe members 160 are secured to the angled gable roofs 20A₁, 20A₂. Depending on the supported needed for the particular installation site, in some embodiments, the mounting brackets 170 may be secured to the gable roof 20A₁ at a location above the bracket assembly 120 (e.g., mounting assembly 2004 shown in FIG. 8D), and in other embodiments, the mounting brackets 170 may be secured to the gable roof 20A₂ at a location below the bracket assembly 120 (e.g., mounting assembly 2005 shown in FIG. 8E).

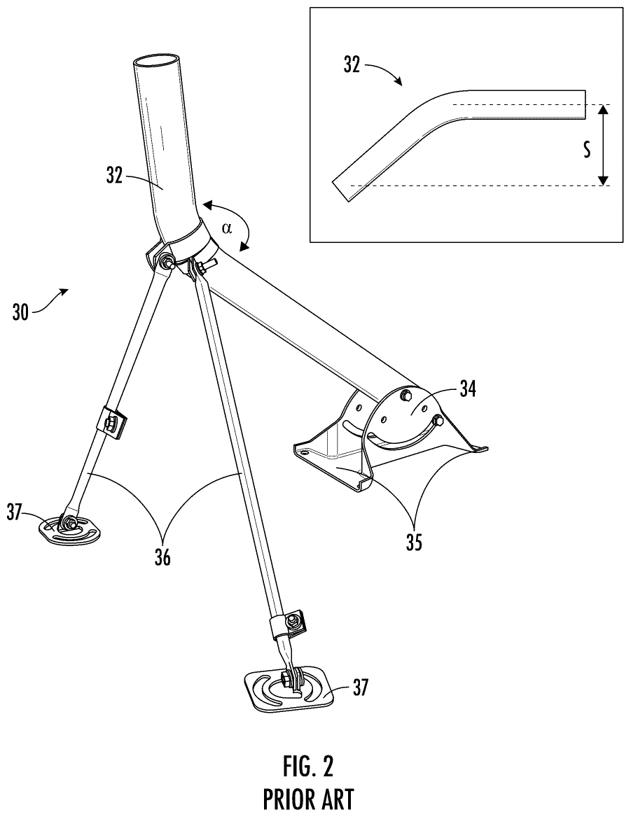

FIGS. 9A-9C further illustrate example mounting assemblies 200₁, 200_{1A}, 200_{1B} that show the adaptability of the antenna mount 100 to accommodate different mounting situations when the antenna mount 100 is secured under a roof eave 20D. Unlike currently available rooftop antenna mounts, such as the fixed-angle mount described above and shown in FIG. 2, in some embodiments, the antenna mount 100 of the present invention is adaptable to be mounted to more protruding roof structures and/or to avoid obstacles. FIG. 9A illustrates the mounting assembly 200₁ in which the antenna mount 100 is secured under a roof eave 20D (see also FIG. 8A). FIG. 9B illustrates a mounting assembly 200_{1A} in which the antenna mount 100 is secured under a shorter roof eave 20D1 while also being positioned to avoid an obstacle 50. FIG. 9C illustrates a mounting assembly 200_{1B} in which the antenna mount 100 is secured under a wider roof eave 20D₂ (i.e., an outer end of the roof eave 20D₂ is a greater distance L from the vertical wall 20C on which the bracket assembly 120 is secured, e.g., compare the mounting assemblies 200₁, 200_{1B} shown in FIGS. 9A-9B).

FIGS. 10A-10E illustrate example steps for installing the antenna mount 100 on a mounting structure 20 (i.e., mounting assembly 200₁ in which the antenna mount 100 is secured under a roof eave 20D) according to embodiments of the present invention. First, as shown in FIG. 10A, an installer selects the appropriate aperture 135a of the adjustment mechanism 135 and inserts a fastener 106 to secure the upper bracket member 130 to an end of the base pipe member 122. Selection of the aperture 135a may be, in-part, based on the length L of the roof eave 20D (i.e., the angular adjustment positions the base pipe member 122 to extend a greater length L than that of the roof eave 20D).

Next, as shown in FIG. 10B, the bracket members 142 of the lower bracket assembly 140 are secured together with the opposing end of the base pipe member 122 clamped therebetween. The lower bracket assembly 140 is then secured to the vertical wall 20C underneath the roof eave 20D. While keeping the upper bracket member 130 in a vertical position, the fasteners 106 are slide within the respective slots 145a of the adjustment mechanism 145 for the lower bracket assembly 140 to position the base pipe member 122 at a desired angular position (relative to the vertical wall 20C). The fasteners 106 are then tightened to secure the base pipe member 122 at the desired angular position.

Next, as shown in FIG. 10C, the antenna mounting pipe 110 is secured to the upper bracket member 130. As described herein, the antenna mounting pipe 110 may be secured to the upper bracket member 130 via mounting plates 124 and fasteners 105 (e.g., U-bolt fasteners). Fasteners 107 (e.g., carriage bolts) are inserted through the apertures in the flanged ends of the upper bracket member 130 (e.g., aperture 138a in upper flanged end 138 as shown in FIG. 10C). The fasteners 107 are received by respective apertures 124a in the mounting plates 124. The antenna mounting pipe 110 is then secured to the mounting plates 124 via the fasteners 105. It is important to ensure that the antenna mounting pipe 110 is in a vertical position before all fasteners 107, 105 are fully tightened.

Next, as shown in FIG. 10D, the mounting brackets 170 are connected to the end of tie-back pipe members 160 and the tie-back pipe members 160 are connected to the antenna mounting pipe 110 (via pipe clamp 150). As shown in FIG. 10E, the tie-back pipe members 160 are positioned within the pipe clamp 150 (and relative to the antenna mounting pipe 110) to secure the antenna mounting pipe 110 at the proper position on the mounting structure 20 (see FIG. 10F). Once the antenna mounting pipe 110 and tie-back pipe members 160 are in their desired positions, all the fasteners (e.g., fasteners 155) are fully tightened. Finally, as shown in FIG. 10F, the antenna 105 is secured to the antenna mounting pipe 110 to complete the installation of the mounting assembly 200₁.

The antenna mount 100 of the present invention provides a number of advantages over prior known mounts, including, but not limited to, being easier and less expensive to manufacture, having a more compact and robust structure, and providing a flexible mid-bracket fixing solution. The process for manufacturing the antenna mount 100 is not restricted by control engineering (e.g., pipe bending), which helps reduce manufacturing costs. The design of the antenna mount 100 optimizes space and decreases package cost. As described herein, the design of the antenna mount 100 is able to adapt to different diameters of antenna mounting pipes 110 without the need for an additional crossover kit. Also as described herein, the antenna mount 100 includes adjustment mechanisms 135, 145 which allow the antenna mount 100 (e.g., the bracket assembly 120) to extend different lengths to effectively avoid various obstacle positions.

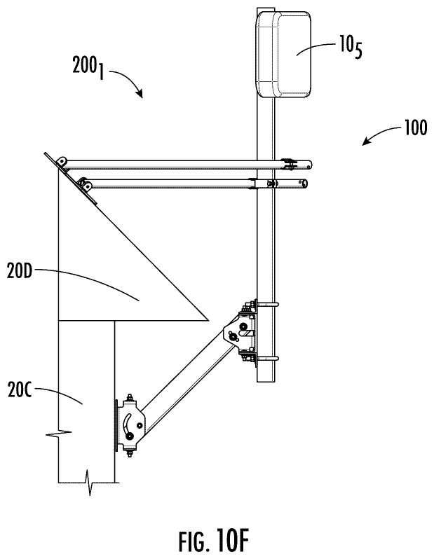

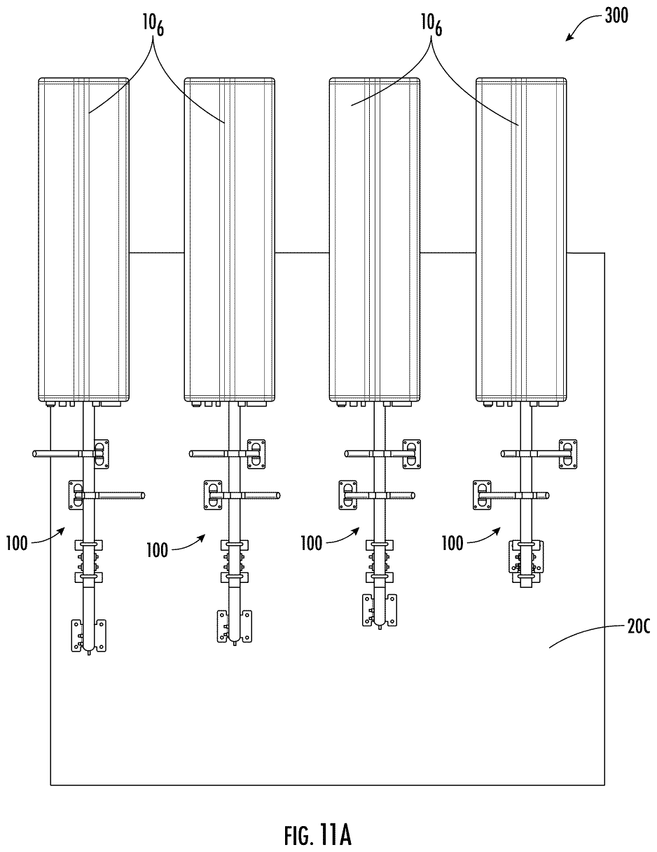

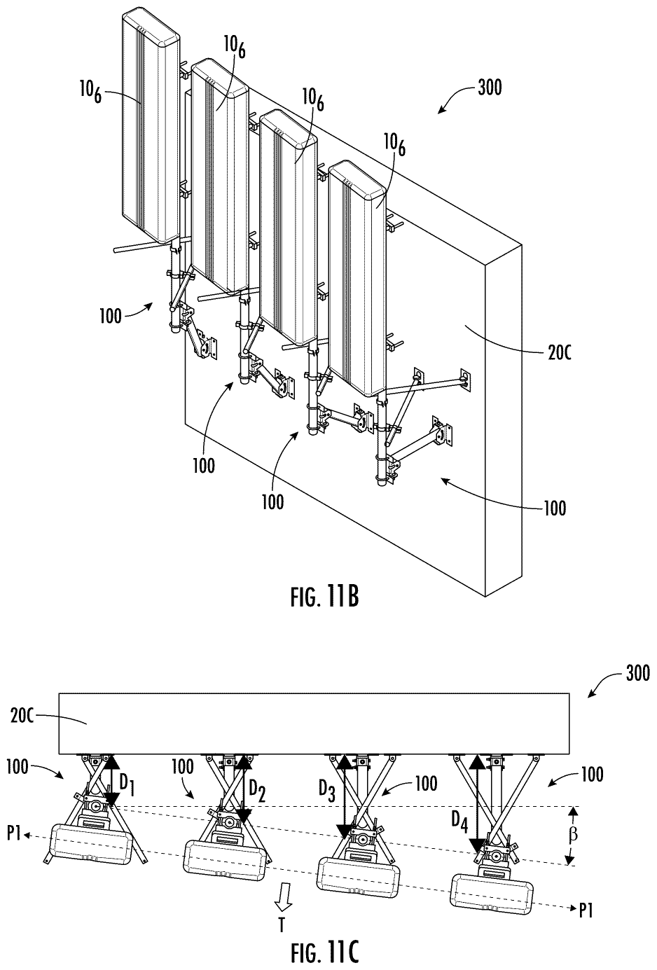

Referring now to FIGS. 11A-11C, an azimuth adjustment system 300 according to embodiments of the present invention is illustrated. As shown in FIGS. 11A-11C, in some embodiments, the azimuth adjustment system 300 may include the antenna mount 100 described herein. Accordingly, properties and/or features of the azimuth adjustment system 300 may be as described above in reference to the antenna mount 100 shown in FIGS. 3A-3C and duplicate discussion thereof may be omitted herein for the purposes of discussing FIGS. 11A-11C.

Often, the side of a building (i.e., vertical wall 20C) does not align with the target azimuth direction (T) of the antenna 10₆. Accordingly, as shown in FIGS. 11A-11C, the antenna mount 100 may be used to easily adjust the distance D₁₋₄ from the vertical wall 20C that each antenna 10₆ is mounted. A “skew” adjustment may be created by varying the distance D₁₋₄ that each antenna 10₆ (i.e., antenna mounting pipe 110) is mounted from the vertical wall 20C to achieve the azimuth adjustment system 300. As shown in FIG. 11C, each antenna 10₆ may then be positioned to face a target azimuth direction (T) (i.e., each antenna 10₆ is positioned on the respective antenna mounting pipe 110 at an angle β). As further shown in FIG. 11C, in some embodiments, the distance D₁₋₄ that each antenna 10₆ (i.e., antenna mounting pipe 110) is mounted from the vertical wall 20C is determined such that each antenna 10₆ is positioned along the same plane P₁ to face the target azimuth direction (T), while also helping to avoid (eliminate) skew interference between the antennas 10₆.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. An antenna mount, the antenna mount comprising:
a vertical mounting pipe configured to have an antenna mounted thereto;
a bracket assembly configured to secure the vertical mounting pipe to a mounting structure, the bracket assembly comprising a base pipe member, an upper bracket member coupled to an end of the base pipe member, and a lower bracket assembly coupled to an opposing end of the base pipe member; and
one or more tie-back pipe members configured to further secure the vertical mounting pipe to the mounting structure.

2. The antenna mount according to claim 1, wherein the upper bracket member is configured to be secured to the vertical mounting pipe and the lower bracket assembly is configured to be secured to the mounting structure.

3. The antenna mount according to claim 1, further comprising a mounting bracket coupled to an end of each tie-back pipe member, the mounting bracket configured to be secured to the mounting structure.

4. The antenna mount according to claim 1, further comprising one or more pipe clamps, each pipe clamp configured to engage the vertical mounting pipe and a respective tie-back pipe member.

5. The antenna mount according to claim 1, wherein the upper bracket member comprises a first adjustment mechanism configured adjust a first mounting angle of the base pipe member relative to the upper bracket member.

6. (canceled)

7. The antenna mount according to claim 1, wherein the upper bracket member further comprises a main section having opposing side members extending outwardly therefrom, the side members extend perpendicularly to the main section and parallel to each other and are configured to be secured to opposing sides of the base pipe member.

8.-9. (canceled)

10. The antenna mount according to claim 1, wherein the upper bracket member comprises a plurality of upper and lower flanged ends configured to engage a respective mounting plate which allows the upper bracket member to secure the bracket assembly to the vertical mounting pipe.

11. The antenna mount according to claim 1, wherein the lower bracket assembly comprises a second adjustment mechanism configured to adjust a second mounting angle of the base pipe member relative to the lower bracket assembly.

12. The antenna mount according to claim 1, wherein the lower bracket assembly comprises two bracket members configured to clamp the opposing end of the base pipe member therebetween.

13.-15. (canceled)

16. The antenna mount according to claim 4, wherein each pipe clamp comprises a first clamping section coupled to a second clamping section, the first clamping section configured to engage the vertical mounting pipe and the second clamping section configured to engage a respective tie-back pipe member.

17. The antenna mount according to claim 3, wherein each mounting bracket comprises a base plate having a pair of tab members extending upwardly therefrom, the corresponding end of the respective tie-back pipe member is configured to fit and be secured between the tab members.

18. (canceled)

19. An antenna mount, the antenna mount comprising:
a vertical mounting pipe configured to have an antenna mounted thereto;
a bracket assembly configured to secure the vertical mounting pipe to a mounting structure, the bracket assembly comprising a base pipe member, an upper bracket member coupled to an end of the base pipe member and configured to be secured to the vertical mounting pipe, and a lower bracket assembly comprising two bracket members configured to clamp an opposing end of the base pipe member therebetween, the lower bracket assembly configured to be secured to the mounting structure;
one or more tie-back pipe members, each tie-back pipe member comprising a mounting bracket coupled to an end that is configured to be secured to the mounting structure; and
one or more pipe clamps, each pipe clamp configured to engage the vertical mounting pipe and a respective tie-back pipe member.

20. The antenna mount according to claim 19, wherein the upper bracket member comprises a first adjustment mechanism configured adjust a first mounting angle of the base pipe member relative to the upper bracket member.

21. (canceled)

22. The antenna mount according to claim 19, wherein the upper bracket member further comprises a main section having opposing side members extending outwardly therefrom, the side members extend perpendicularly to the main section and parallel to each other and are configured to be secured to opposing sides of the base pipe member.

23.-24. (canceled)

25. The antenna mount according to claim 19, wherein the upper bracket member comprises a plurality of upper and lower flanged ends configured to engage a respective mounting plate which allows the upper bracket member to secure the bracket assembly to the vertical mounting pipe.

26. The antenna mount according to claim 19, wherein the lower bracket assembly comprises a second adjustment mechanism configured to adjust a second mounting angle of the base pipe member relative to the lower bracket assembly.

27. The antenna mount according to claim 19, wherein the lower bracket assembly comprises two bracket members configured to clamp the opposing end of the base pipe member therebetween.

28.-30. (canceled)

31. The antenna mount according to claim 19, wherein each pipe clamp comprises a first clamping section coupled to a second clamping section, the first clamping section configured to engage the vertical mounting pipe and the second clamping section configured to engage a respective tie-back pipe member.

32. The antenna mount according to claim 19, wherein each mounting bracket comprises a base plate having a pair of tab members extending upwardly therefrom, the corresponding end of the respective tie-back pipe member is configured to fit and be secured between the tab members.

33. (canceled)

34. An azimuth adjustment system, the azimuth adjustment system comprising two or more antenna mounts according to claim 1, wherein each antenna mount is mounted to a vertical wall, and wherein the vertical mounting pipes for each antenna mount are positioned at different distances from the vertical wall, thereby allowing an antenna mounted to each vertical mounting pipe to be positioned to face a target azimuth direction without interference from an adjacent antenna.
